(19) United States
(12) Patent Application Publication
(10) Pub. No.: US 2013/0265132 A1
(43) Pub. Date: Oct. 10, 2013

(54) ON-CHIP TRANSFORMER HAVING MULTIPLE WINDINGS

(71) Applicants: Kai-Yi Huang, Taipei (TW); Yu-Hsin Chen, Taipei (TW)

(72) Inventors: Kai-Yi Huang, Taipei (TW); Yu-Hsin Chen, Taipei (TW)

(73) Assignee: REALTEK SEMICONDUCTOR CORP., HSINCHU (TW)

(21) Appl. No.: 13/857,794

(22) Filed: Apr. 5, 2013

(30) Foreign Application Priority Data
Apr. 6, 2012 (TW) 101112244

(51) Int. Cl. H01F 27/28; H01F 27/29

(52) U.S. Cl. CPC H01F 27/2804; H01F 27/29
USPC 336/192; 336/200

(57) ABSTRACT

An on-chip transformer formed on an integrated-circuit substrate is disclosed. The on-chip transformer includes: a multi-winding structure comprising first, second and third windings which are spatially separated from each other; and a guard ring surrounding the multi-winding structure; wherein the first and second windings function as a first transformer, and the second and third windings function as a second transformer.

### CROSS-REFERENCE TO RELATED APPLICATIONS STATEMENT

This non-provisional application claims priority under 35 U.S.C. §119(a) on Patent Application No. 101112244 filed in Taiwan, R.O.C. on Apr. 6, 2012, the entire contents of which are hereby incorporated by reference.

### TECHNICAL FIELD

The present disclosure relates to an on-chip transformer, and more particularly, to an on-chip transformer having at least three windings formed on an integrated-circuit substrate.

### TECHNICAL BACKGROUND

Transmitters, antennae and receivers are essential components in the wireless communication system, where signals transmitted in the atmosphere are of single-ended type while signals processed in the differential circuits of the transmitters are of differential type. The transmitters have to convert differential signals processed in their interior circuits into single-ended signals before their output signals are forwarded to the antennae to be radiated electromagnetically into the air. On the other hand, the receivers have to convert single-ended signals received by the antennae into differential signals before the signals are forwarded to the low noise amplifier (LNA) in the receivers. Usually, the conversion between the differential and single-ended signals is performed by a transformer balun, which has a transformer coil at each of its transmitting and receiving terminals. If the transformer coils are realized in the form of integrated-circuit (IC) chip, they may spend a quite large chip area.

As the advance of the system on chip (SoC) in the IC manufacturing, a discrete transformer is gradually replaced by an integrated transformer and applied to the radio-frequency integrated circuit (RFIC). However, some passive devices like inductors and transformers often consume a large chip area. Consequently, it is in need to develop a new on-chip transformer with a smaller layout area while without loss of its operational performance, such as quality factor, coupling coefficient, and impedance matching.

### TECHNICAL SUMMARY

According to one aspect of the present disclosure, one embodiment provides an on-chip transformer on an integrated-circuit substrate. The on-chip transformer includes: a multi-winding structure comprising first, second and third windings which are spatially separated from each other; and a guard ring surrounding the multi-winding structure; wherein the first and second windings function as a first transformer, and the second and third windings function as a second transformer.

According to another aspect of the present disclosure, another embodiment provides an on-chip transformer on an integrated-circuit substrate. The on-chip transformer includes: a first winding; a second winding; and a third winding; wherein the first, second, and third windings are separated from each other and wrap around each other, the first and second windings function as a first transformer, and the second and third windings function as a second transformer.

According to another aspect of the present disclosure, another embodiment provides an on-chip transformer on an integrated-circuit substrate. The on-chip transformer includes: a first winding; a second winding; and a third winding; wherein the first, second, and third windings are separated from each other and wrap around each other, and vertical views upon the substrate of the second and third windings are located inside that of the outermost coil of the first winding.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1A schematically shows a vertical view of an on-chip transformer having multiple windings according to a first embodiment of the present disclosure.

FIG. 1B shows an equivalent circuit of the on-chip transformer in FIG. 1A.

FIG. 2 shows a cross-sectional diagram of the on-chip transformer taken along the A-A′ line in FIG. 1A.

FIG. 3A shows the wiring layout of the first winding in FIG. 1A.

FIG. 3B shows the wiring layout of the second winding in FIG. 1A.

FIG. 3C shows the wiring layout of the third winding in FIG. 1A.

FIG. 4A schematically shows a layout of an on-chip transformer having multiple windings according to a second embodiment of the present disclosure.

FIG. 4B illustrates an equivalent circuit of the on-chip transformer in FIG. 4A.

FIG. 5A schematically shows a layout of an on-chip transformer having multiple windings according to a third embodiment of the present disclosure.

FIG. 5B illustrated an equivalent circuit of the on-chip transformer in FIG. 5A.

FIG. 6 schematically shows a layout of an on-chip transformer having three windings according to a fourth embodiment of the present disclosure.

FIG. 7A schematically shows a layout of an on-chip transformer having multiple windings according to a fifth embodiment of the present disclosure.

FIG. 7B is a cross-sectional diagram of the on-chip transformer in FIG. 7A.

FIG. 7C illustrated an equivalent circuit of the on-chip transformer in FIG. 7A.

FIG. 8A schematically shows a layout of an on-chip transformer having multiple windings according to a sixth embodiment of the present disclosure.

FIG. 8B is a cross-sectional diagram of the on-chip transformer in FIG. 8A.

FIG. 8C illustrated an equivalent circuit of the on-chip transformer in FIG. 8A.

### DESCRIPTION OF THE EXEMPLARY EMBODIMENTS

For further understanding and recognizing the fulfilled functions and structural characteristics of the disclosure, several exemplary embodiments cooperating with detailed description are presented as the following. Reference will now be made in detail to the preferred embodiments, examples of which are illustrated in the accompanying drawings.

In the following description of the embodiments, it is to be understood that when an element such as a layer (film), region, pattern, or structure is stated as being “on” or “under” another element, it can be “directly” on or under another element or can be “indirectly” formed such that an intervening element is also present. Also, the terms such as “on” or “under” should be understood on the basis of the drawings, and they may be used herein to represent the relationship of one element to another element as illustrated in the figures. It will be understood that this expression is intended to encompass different orientations of the elements in addition to the orientation depicted in the figures, namely, to encompass both “on” and “under”. In addition, although the terms “first”, “second” and “third” are used to describe various elements, these elements should not be limited by the term. Also, unless otherwise defined, all terms are intended to have the same meaning as commonly understood by one of ordinary skill in the art.

The present disclosure relates to an on-chip transformer having multiple windings, which can be formed in a multi-layered structure on a semiconductor substrate or wafer by using the integrated-circuit manufacturing. The on-chip transformer has at least three windings each composed of wire coils, according to function or requirement of the circuit it belongs to. The windings may be formed in one layer of the multi-layered structure, and they may be formed in several layers of the multi-layered structure. Each winding includes one or more wire coils, and their wiring layouts are spatially separated from each other. Two or more transformers can perform voltage conversion, according to the electromagnetic coupling effect between various windings. The windings wrap and surround around each other, so as to form a multi-winding configuration.

In case a winding is formed in one layer of the multi-layered structure, its wire coils may intersect. To keep the coils electrically separated from each other, one wire at the intersection can overpass the other one through a bridge jumper formed in the other layers of the multi-layered structure. Although the winding is not distributed completely in the one layer of the multi-layered structure, but it can be regarded as being formed substantially in one single layer.

Hereinafter, on-chip transformers having three or more windings according to embodiments of the present disclosure is going to be described in detail with reference to the accompanying drawings.

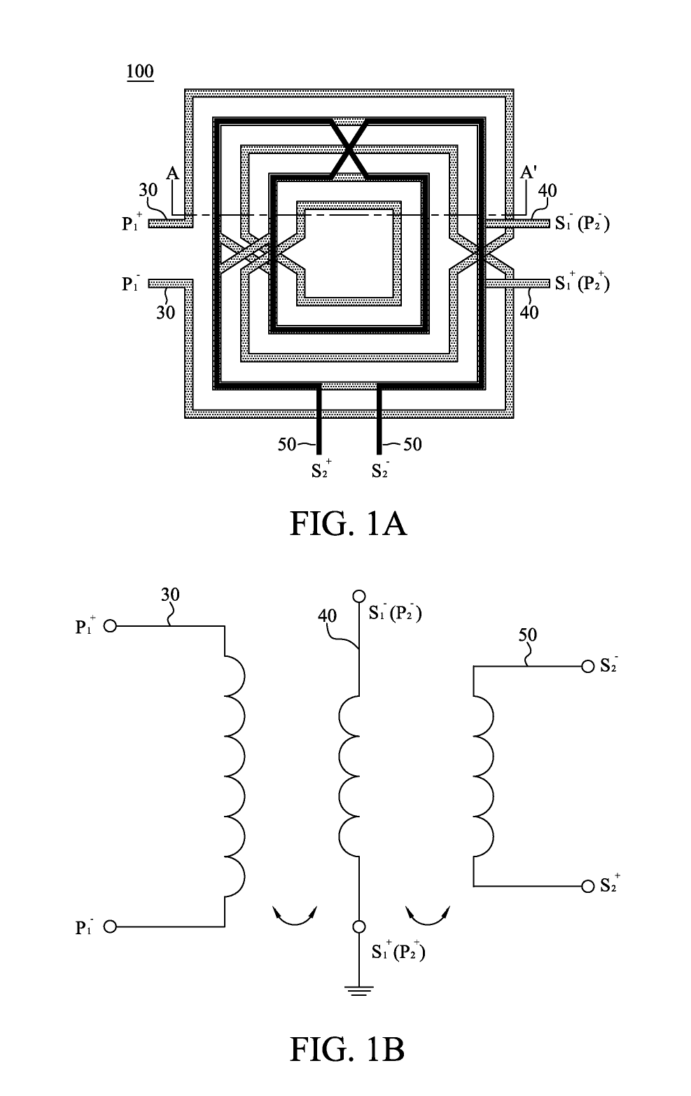

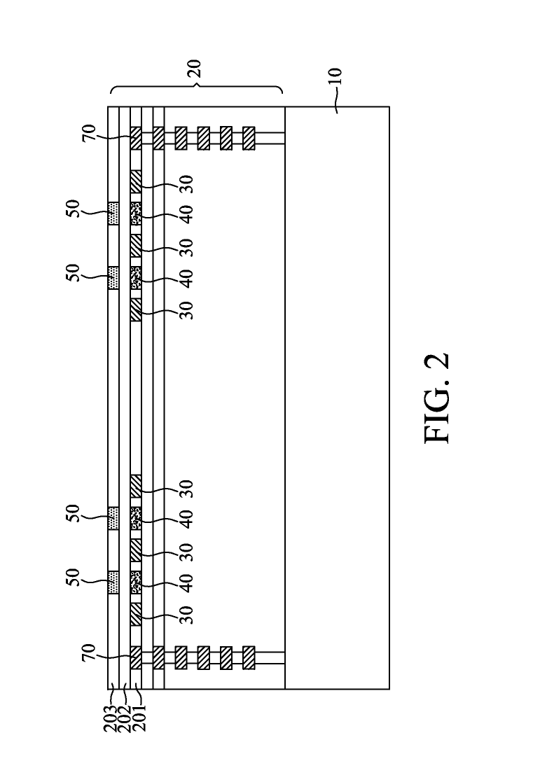

FIG. 1A schematically shows a vertical view of an on-chip transformer having multiple windings according to a first embodiment of the present disclosure, and FIG. 2 is a cross-sectional diagram of the on-chip transformer taken along the A-A′ line in FIG. 1A. As shown in FIG. 1A, the on-chip transformer 100 comprises a multi-winding structure formed in a multi-layered structure 20 on a substrate 10. The multi-winding structure includes a first winding 30, a second winding 40, and a third winding 50, which are separated from each other. In another embodiment, the on-chip transformer 100 may further include a guard ring 70. Preferably, the guard ring 70 is composed of stacked metal rings surrounding the multi-winding structure and formed in the multi-layered structure 20, as shown in FIG. 2. The guard ring 70 can keep the on-chip transformer 100 isolated, so that the transformer inside the guard ring 70 and the devices outside the guard ring 70 may not interfere with each other electromagnetically. Furthermore, there's no more guard ring needed inside the guard ring 70. The substrate 10 can be a semiconductor substrate or a flexible substrate. The first, second and third windings 30, 40 and 50 form transformers with three windings.

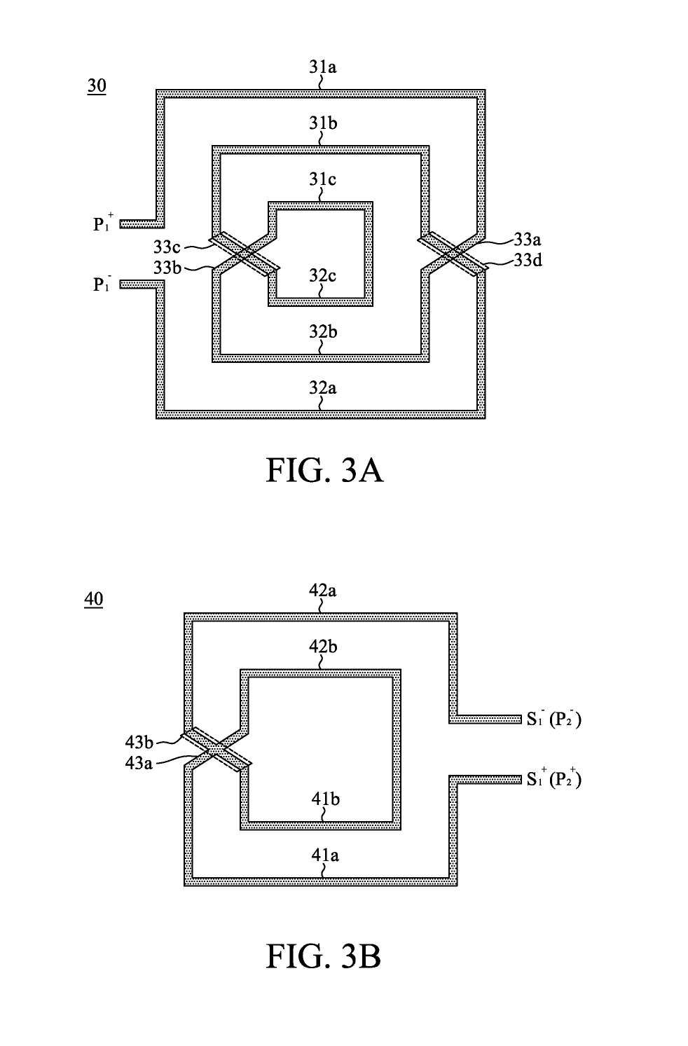

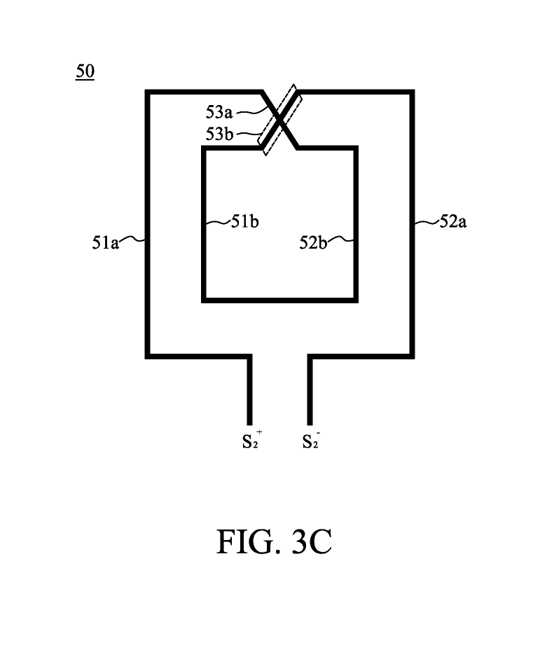

The first winding 30 is composed of multiple first coils and substantially disposed in a first layer 201 of the multi-layered structure 20. FIG. 3A shows the wiring layout of the first winding 30 in FIG. 1A. As shown in FIG. 3A, the first winding 30 may include plural first semi-turn wires 31a/31b/31c, plural second semi-turn wires 32a/32b/32c, and plural bridge jumpers 33a/33b/33c/33d. For example, the first semi-turn wire 31a and the second semi-turn wire 32b are connected by the bridge jumper 33a to form one of the first coils, in which the first semi-turn wire 31a and the second semi-turn wire 32b have a similar shape but different sizes and are disposed symmetrically. The first semi-turn wire 31a, the bridge jumper 33a, and the second semi-turn wire 32b are all formed in the first layer 201. On the other hand, the first semi-turn wire 31c and the second semi-turn wire 32c are connected by the bridge jumper 33b and/or 33c to form the other first coil, in which the first semi-turn wire 31c and the second semi-turn wire 32c have a similar shape but different sizes and are disposed symmetrically. The first semi-turn wire 31c, the bridge jumper 33b, and the second semi-turn wire 32c are also formed in the first layer 201. The bridge jumper 33c at the wire intersection is formed in another layer, so that the first semi-turn wire 31b and the second semi-turn wire 32c can be connected. Similarly, the first semi-turn wire 31b and the second semi-turn wire 32a are connected by the bridge jumper 33d to form the other first coil, in which the first semi-turn wire 31b and the second semi-turn wire 32a have a similar shape but different sizes and are disposed symmetrically. The first semi-turn wire 31b and the second semi-turn wire 32a are also formed in the first layer 201, while the bridge jumper 33d intersecting the bridge jumper 33a at the wire intersection is formed in another layer, so that the first semi-turn wire 31b and the second semi-turn wire 32a can be connected. In such a way, the first coils can be connected to form a continuous wire path without short circuit between themselves. As shown in FIG. 3A, the first coils wrap around each other in a helix-like pattern, so as to improve the coil density. In other words, each first coil is basically composed one first semi-turn wire 31a/31b/31c, one second semi-turn wire 32a/32b/32c, and one bridge jumper 33a/33b/33c/33d; but is not limited thereto, the first coil can be formed in various ways of connection or layout.

The second winding 40 is composed of multiple second coils and substantially disposed in the first layer 201 (the same layer in which the first winding 30 is distributed) of the multi-layered structure 20. FIG. 3B shows the wiring layout of the second winding 40 in FIG. 1A. As shown in FIG. 3B, the second winding 40 may include plural first semi-turn wires 41a/41b, plural second semi-turn wires 42a/42b and plural bridge jumpers 43a/43b, and their connections form the second coils are similar to those of the first coils of the first winding 30, as described in the preceding paragraph. Wherein, wiring patterns of the first and second windings 30 and 40 are in squire or rectangle shapes; but it is not limited thereto, they can be shaped in a circle, octagon, or another shape which can improve performances of the transformer.

The first and second windings 30 and 40 are disposed in the same layer 201, so electromagnetic coupling can be formed therebetween horizontally or laterally, and a transformer can be formed accordingly. Wirings of the first and second windings 30 and 40 are spatially separated from and parallel to each other. To improve efficiency of the electromagnetic coupling effect, the first and second coils are arranged in an inter-digital wiring structure as shown in FIG. 1A according the embodiment. Also, the arrangement may cause a denser wiring pattern, so that the on-chip transformer can have a much smaller chip area.

The third winding 50 is composed of multiple third coils and is substantially disposed in a second layer 203 (differing from the first layer 201 in which the first and second winding 30 and 40 are located) of the multi-layered structure 20. A layer 202 of insulator material is interposed between the first layer 201 and the second layer 202. The third winding 50 may have a wiring pattern different from that of the second winding 40 or as same as that of the second winding 40 but with a certain rotational angle, so that accessing terminals of the windings can be connected to the other devices on the chip in a shortest wiring path. Thus, the parasitical capacitors and inductors induced by transmission-line wiring can be diminished so as to optimize the circuit layout. In the embodiment, the wiring pattern of the third winding 50 vertically overlaps that of the second winding 40 in large part, so electromagnetic coupling can be formed therebetween vertically and another transformer can be formed accordingly. As shown in FIGS. 3B and 3C, the third winding 50 has the same wiring pattern as that of the second winding 40 but with a rotational angle of about 90′; but it is not limited thereto, the rotational angle can be another suitable angle. Also, the third winding 50 may include plural first semi-turn wires 51a/51b, plural second semi-turn wires 52a/52b, and plural bridge jumpers 53a/53b, and their connections to form the third coils are similar to those of the first coils of the first winding 30, as described in the preceding paragraph. Wirings of the second and third windings 40 and 50 are spatially separated from and vertically parallel to each other. To improve efficiency of the electromagnetic coupling effect, the third coils 50 are arranged exactly over the second coils 40, as shown in FIG. 2, according the embodiment; but it is not limited thereto, some offset, overlapping in part, and non-centric symmetry are possible in the wiring arrangement between the second and third coils.

As shown in FIGS. 1A and 2, vertical views of the second and third windings 40 and 50 upon the substrate 10 are located inside that of the outermost coil of the first winding 30. In other words, layouts of the second and third windings 40 and 50 projected vertically onto the substrate 10 are located inside that of the outermost coil of the first winding 30. In addition, the second layer 203 is above the first layer 201 as shown in FIG. 2, but it can be located below the first layer 201 in another embodiment, so that the third winding 50 is located below the second winding 40.

Consequently, the on-chip transformer 100 shown in FIG. 1A is a transformer having three windings, and its equivalent circuit can be illustrated in FIG. 1B. The first winding 30, second winding 40 and third winding 50 wrap each other while are spatially separated from each other, and each has two connection terminals. The first and second windings 30 and 40 may form a first transformer according to the lateral electromagnetic coupling effect therebetween. As shown in FIG. 1B, the first winding 30 acts as the primary winding of the first transformer with its positive-pole and negative-pole connection terminals respectively denoted as P₁⁺ and P₁⁻, while the second winding 40 acts as the secondary winding of the first transformer with its positive-pole and negative-pole connection terminals respectively denoted as S₁⁺ and S₁⁻. Moreover, the second and windings 40 and 50 may form a second transformer according to the vertical electromagnetic coupling effect therebetween. As shown in FIG. 1B, the second winding 40 acts as the primary winding of the second transformer with its positive-pole and negative-pole connection terminals respectively denoted as P₂⁺ and P₂⁻, while the third winding 50 acts as the secondary winding of the second transformer with its positive-pole and negative-pole connection terminals respectively denoted as S₂⁺ and S₂⁻. The second winding 40 is the common winding shared by the first and second transformers. For each transformer, connection terminals of its primary and secondary windings can be connected to their access wires, which are angled at 180° (e.g., the first transformer in the embodiment of FIG. 1A), 90° (e.g., the second transformer in the embodiment of FIG. 1A), 45° (e.g., a transformer with an octagonal wiring layout), or any suitable angle (e.g., a transformer with a circle wiring layout). Formed along a suitable direction, the access wires causes that the connection terminals of the windings can be connected to the other devices on the chip in a shortest wiring path, so that the parasitical capacitors and inductors induced by transmission-line wiring can be diminished so as to optimize the circuit layout.

The on-chip transformer 100 according to the first embodiment of FIG. 1A can then be used to develop two transformer baluns, each of which converts between a balanced signal and an unbalanced signal, of a transceiver for wireless communication, so that the transceiver can be developed in an integrated-circuit device; but the on-chip transformer 100 according the present disclosure is not limited to the above recited application.

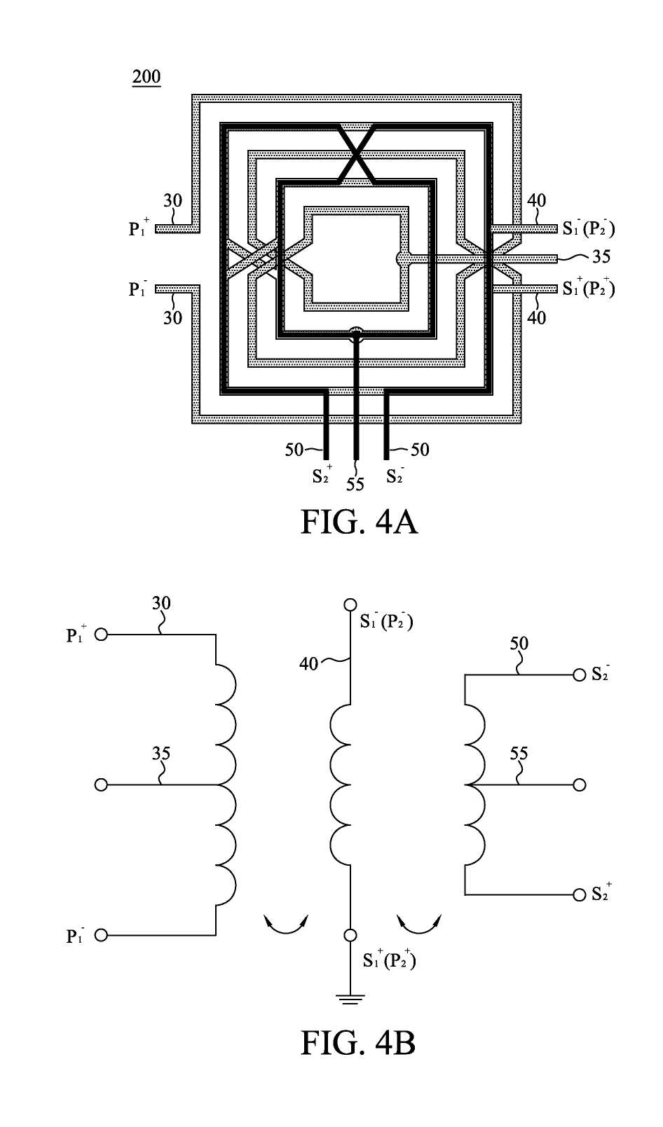

FIG. 4A schematically shows a layout of an on-chip transformer having multiple windings according to a second embodiment of the present disclosure. The on-chip transformer 200 comprises a first winding 30, a second winding 40 and a third winding 50 formed in a multi-layered structure on a substrate. The windings 30/40/50 wrap each other while are separated from each other, so as to form transformer baluns with three windings. The transformer of the present embodiment has similar composition and structure to that of the first embodiment, and the redundancies will not be described again. In the embodiment, the first and second windings 30 and 40 may form a first transformer according to the lateral electromagnetic coupling effect therebetween. FIG. 4B illustrated an equivalent circuit of the on-chip transformer 200 in FIG. 4A. As shown in FIG. 4B, the first winding 30 acts as the primary winding of the first transformer with its positive-pole and negative-pole connection terminals respectively denoted as P₁⁺ and P₁⁻, while the second winding 40 acts as the secondary winding of the first transformer with its positive-pole and negative-pole connection terminals respectively denoted as S₁⁺ and S₁⁻. Furthermore, the second and windings 40 and 50 may form a second transformer according to the vertical electromagnetic coupling effect therebetween. The second winding 40 acts as the primary winding of the second transformer with its positive-pole and negative-pole connection terminals respectively denoted as P₂⁺ and P₂⁻, while the third winding 50 acts as the secondary winding of the second transformer with its positive-pole and negative-pole connection terminals respectively denoted as S₂⁺ and S₂⁻. The second winding 40 is the common winding shared by the first and second transformers. The first winding 30 further includes a first center tap 35, which is a tap located at the winding center, to be used for a two-ended signal, such as a differential signal. The first center tap 35 can have its access wire with a direction angle of 90°, 180°, or the other proper degree against the access wire of the primary winding of the first transformer, so that it can be connected to the other devices on the chip in a shortest wiring path. Furthermore, the third winding 50 further includes a second center tap 55, which is a tap located at the winding center, to be used for a differential signal. The second center tap 55 can have its access wire with a direction angle of 90°, 180°, or the other proper degree against the access wire of the primary winding of the second transformer. As shown in FIG. 4B, the positive-pole connection terminal P₂⁺ (S₁⁺) is grounded, so that the first transformer can be used for converting a differential signal to a single-ended signal while the second transformer can be used for converting a single-ended signal to a differential signal.

The three-winding transformer 200 in FIG. 4A can be used to construct a wireless transceiver. When the transceiver operates in the transmission mode, a differential signal connected to the primary winding of the first transformer from a common-gate power amplifier can be converted into a single-ended signal at the secondary winding of the first transformer, so as to be transmitted to the atmosphere through an antenna. On the other hand, when the transceiver operates in the receiver mode, a single-ended signal is received through an antenna and then inputted to the primary winding of the second transformer, to be converted into a differential signal at the secondary winding of the second transformer, so as to be offered to an low-noise amplifier (LNA) of differential type as an input signal.

In another embodiment, the first winding 30 can be formed in several layers of the multi-layered structure 20. For example, the first winding 30 can be partly formed in the first layer 201 and partly formed in the second layer 203, so that the first winding 30 is generally parallel to the second winding 40. In some embodiments, the second or third winding 40 or 50 can also be formed in several layers of the multi-layered structure 20. The electromagnetic coupling among the first, second and third winding 30, 40 and 50 can be in vertical or lateral direction partly or completely.

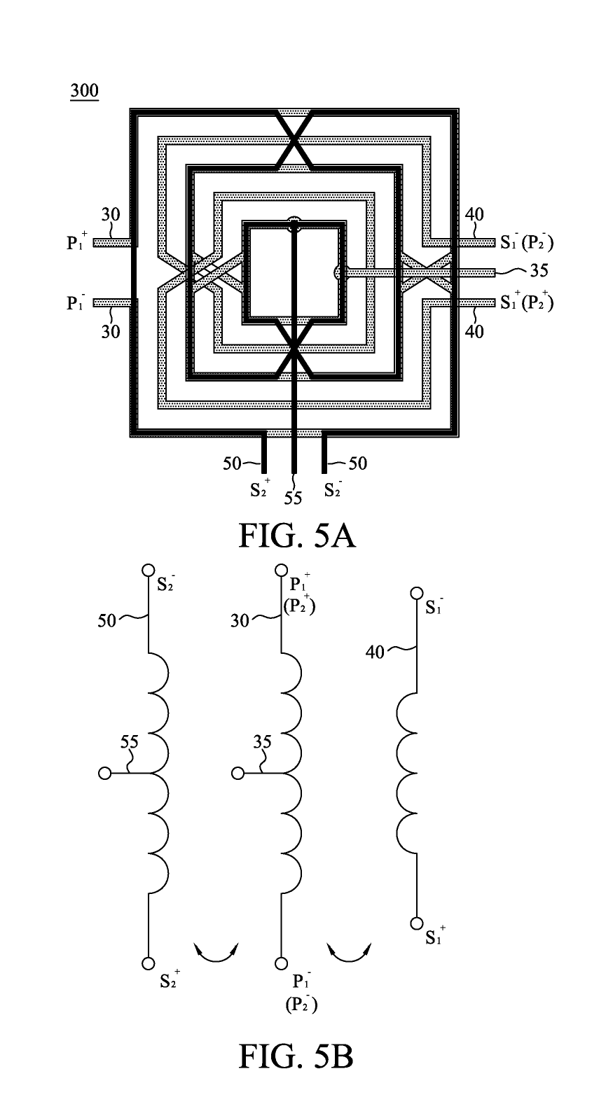

FIG. 5A schematically shows a layout of an on-chip transformer having multiple windings according to a third embodiment of the present disclosure. The on-chip transformer 300 comprises a first winding 30, a second winding 40 and a third winding 50 formed in a multi-layered structure on a substrate. The windings 30/40/50 wrap each other while are separated from each other, so as to form transformer baluns with three windings. The transformer of the present embodiment has similar composition and structure to that of the first embodiment, and the redundancies will not be described again. In the embodiment, the third winding 50 has a wiring pattern basically the same as that of the first winding 30, and the first winding 30 are vertically stacked on the third winding 50 in large part, so electromagnetic coupling can be formed therebetween vertically. The first and second windings 30 and 40 may form a first transformer according to the lateral electromagnetic coupling effect therebetween. FIG. 5B illustrated an equivalent circuit of the on-chip transformer 300 in FIG. 5A. As shown in FIG. 5B, the first winding 30 acts as the primary winding of the first transformer with its positive-pole and negative-pole connection terminals respectively denoted as P₁⁺ and P₁⁻, while the second winding 40 acts as the secondary winding of the first transformer with its positive-pole and negative-pole connection terminals respectively denoted as S₁⁻ and S₁⁻. Furthermore, the first and windings 30 and 50 may form a second transformer according to the vertical electromagnetic coupling effect therebetween. The first winding 30 acts as the primary winding of the second transformer with its positive-pole and negative-pole connection terminals respectively denoted as P₂⁺ and P₂⁻, while the third winding 50 acts as the secondary winding of the second transformer with its positive-pole and negative-pole connection terminals respectively denoted as S₂⁺ and S₂⁻. The first winding 30 is the common winding shared by the first and second transformers. The first winding 30 further includes a first center tap 35, which is a tap located at the winding center, to be used for a differential signal. Also, the third winding 50 further includes a second center tap 55, which is a tap located at the winding center, to be used for a differential signal. Each center tap 35/55 can have its access wire with a direction angle of 90°, 180°, or the other proper angle degree against the access wire of the primary winding of the corresponding transformer. As shown in FIG. 5B, the first transformer can act as a transformer balun to convert a differential signal to a single-ended signal, and the second transformer can act as another transformer balun to convert a differential signal to another differential signal.

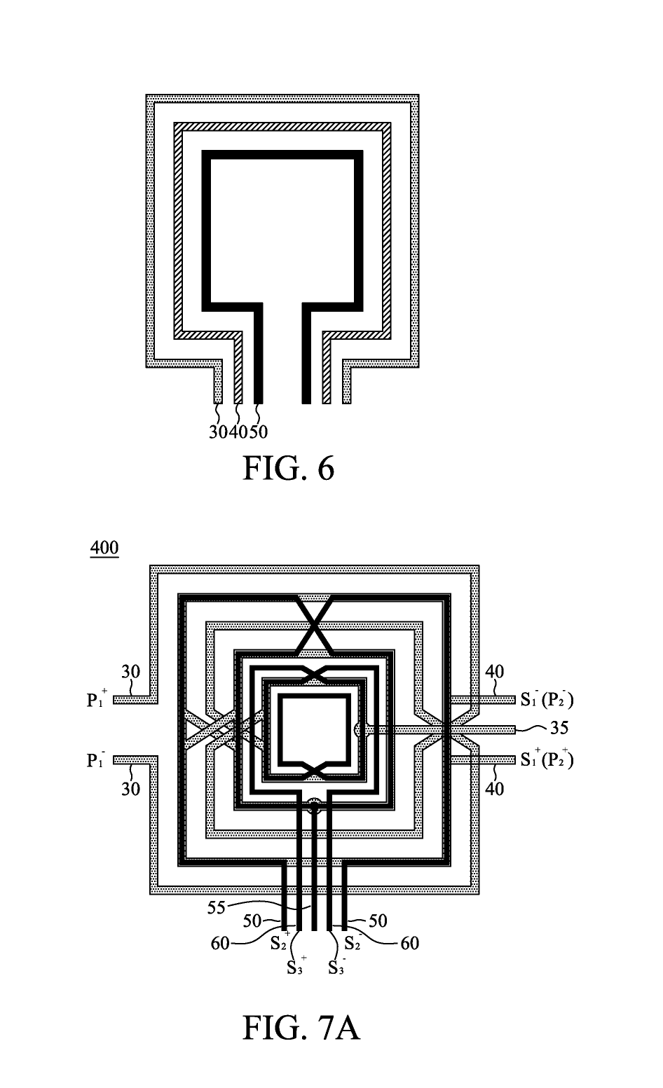

Moreover, the foregoing three-winding transformer can be configured in another type of structure. FIG. 6 schematically shows a layout of an on-chip transformer having three windings according to a fourth embodiment of the present disclosure. The on-chip transformer comprises a first winding 30, a second winding 40 and a third winding 50 formed in a multi-layered structure on a substrate. The windings 30/40/50 wrapping each other while separated from each other can be formed in a common layer or in several layers. If the windings 30/40/50 are formed in a common layer, they can form first and second transformers according to their respective lateral electromagnetic coupling effect therebetween.

In the above described embodiments, the electromagnetic coupling between two of the first, second and third winding 30, 40 and 50 can be lateral or vertical, according to their wiring patterns and layer distributions; this disclosure is not limited thereto.

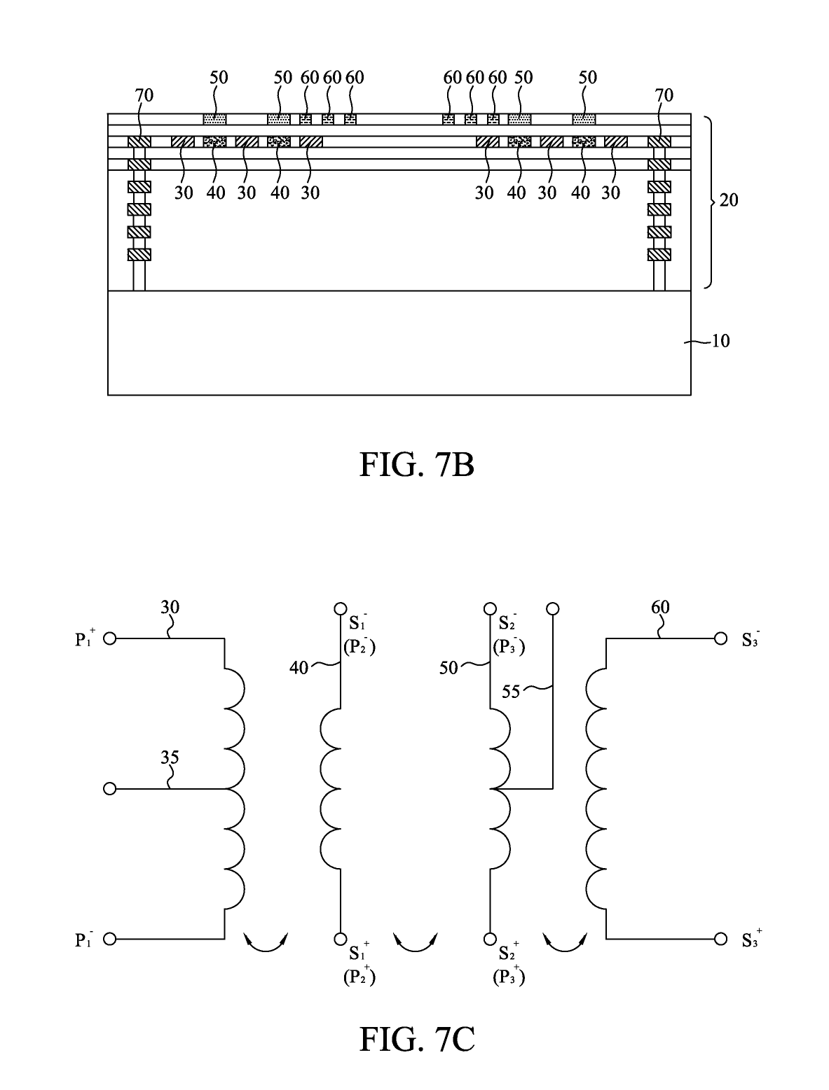

The on-chip transformer according to the present disclosure may have more than three windings. FIG. 7A schematically shows a layout of an on-chip transformer having multiple windings according to a fifth embodiment of the present disclosure, and FIG. 7B is its cross-sectional diagram. As shown in FIGS. 7A and 7B, the on-chip transformer 400 comprises a first winding 30, a second winding 40, a third winding 50, and a fourth winding 60 formed in a multi-layered structure 20 on a substrate 10. The windings 30/40/50/60 wrap each other while are separated from each other, so as to form transformer baluns with four windings. In the embodiment, the on-chip transformer 400 may further include a guard ring 70, which is composed of stacked metal rings surrounding the multi-winding structure and formed in the multi-layered structure 20, as shown in FIG. 7B. Basically, the transformer 400 of the embodiment is composed of the transformer 100 of the first embodiment and the fourth winding 60 formed in the second layer of the multi-layered structure 20, where the third winding 50 is also located. The fourth winding 60 is composed of multiple fourth coils, which may include plural first semi-turn wires, plural second semi-turn wires, and plural bridge jumpers, and their connections form the second coils are similar to those of the first coils of the first winding 30 in the first embodiment. The forth and third windings 60 and 50 are disposed in the same layer, so electromagnetic coupling can be formed therebetween horizontally or laterally to form a transformer. Wirings of the forth and third windings 60 and 50 are spatially separated from and parallel to each other. As shown in FIGS. 7A and 7B, the fourth coils in the embodiment are surrounded completely by the third coils, so that the wiring patterns can be arranged as dense as possible to achieve a smallest chip area. The wiring patterns of the forth and third windings 60 and 50 may intersect; in such a case, bridge jumpers can be interposed between the windings 60 and 50 at the intersection to separate the windings 60 and 50.

In the embodiment, the first and second windings 30 and 40 may form a first transformer according to the lateral electromagnetic coupling effect therebetween. FIG. 7C illustrated an equivalent circuit of the on-chip transformer 300 in FIG. 7A. As shown in FIGS. 7A and 7C, the first winding 30 acts as the primary winding of the first transformer with its positive-pole and negative-pole connection terminals respectively denoted as P₁⁺ and P₁⁻, while the second winding 40 acts as the secondary winding of the first transformer with its positive-pole and negative-pole connection terminals respectively denoted as S₁⁺ and S₁⁻. The second and third windings 40 and 50 may form a second transformer according to the vertical electromagnetic coupling effect therebetween. The second winding 40 acts as the primary winding of the second transformer with its positive-pole and negative-pole connection terminals respectively denoted as P₂⁺ and P₂⁻, while the third winding 50 acts as the secondary winding of the second transformer with its positive-pole and negative-pole connection terminals respectively denoted as S₂⁺ and S₂⁻. Furthermore, the third and fourth windings 50 and 60 may form a third transformer according to the lateral electromagnetic coupling effect therebetween. The third winding 50 acts as the primary winding of the third transformer with its positive-pole and negative-pole connection terminals respectively denoted as P₃⁺ and P₃⁻, while the fourth winding 60 acts as the secondary winding of the third transformer with its positive-pole and negative-pole connection terminals respectively denoted as S₃⁺ and S₃⁻. The second winding 40 is the common winding shared by the first and second transformers, and the third winding 50 is the common winding shared by the second and third transformers. As shown in FIG. 7A, the first winding 30 further includes a first center tap 35, which is a tap located at the winding center, to be used for a differential signal. The center tap 35 can have its access wire with a direction angle of 180° as against the access wire of the primary winding of the first transformer. The third winding 50 further includes a second center tap 55, which is a tap located at the winding center, to be used for a differential signal. The center tap 55 can have its access wire with a direction angle of 90° as against the access wire of the primary winding of the second transformer. Accordingly, the first transformer can act as a transformer balun to convert a differential signal to a single-ended signal, the second transformer can act as another transformer balun to convert a single-ended signal to a differential signal, and the third transformer can act as another transformer balun to convert a differential signal to a single-ended signal.

The four-winding transformer 400 in FIG. 7A can be applied to construct a wireless transceiver. When the transceiver operates in the transmission mode, a differential signal connected to the primary winding of the first transformer from a common-gate power amplifier can be converted into a single-ended signal at the secondary winding of the first transformer, so as to be transmitted to the atmosphere through an antenna. On the other hand, when the transceiver operates in the receiver mode, a single-ended signal is received through an antenna and then inputted to the primary winding of the second transformer, to be converted into a differential signal at the secondary winding of the second transformer, so as to be offered to an low-noise amplifier (LNA) of differential type as an input signal. Furthermore, the differential-type coils at the secondary winding of the second transformer can also act as the primary winding of the third transformer, whereas the secondary winding of the third transformer is disposed in the same layer and wrapped inside its primary winding, so electromagnetic coupling can be formed therebetween laterally to be used as the LNA's loading.

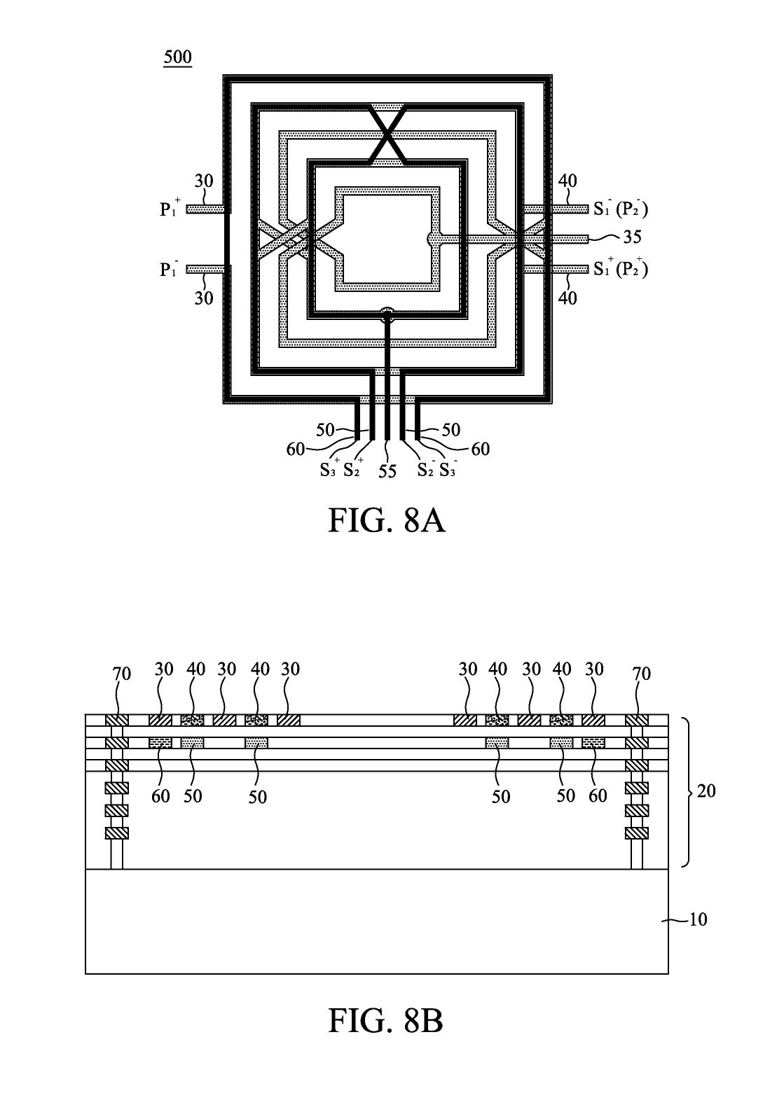

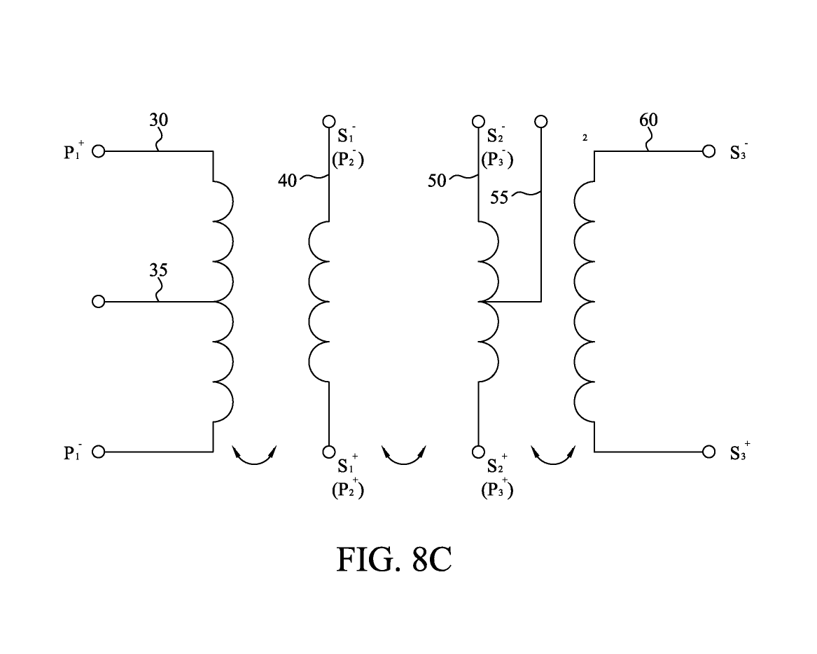

FIG. 8A schematically shows a layout of an on-chip transformer having multiple windings according to a sixth embodiment of the present disclosure, and FIG. 8B is its cross-sectional diagram. As shown in FIGS. 8A and 8B, the on-chip transformer 500 comprises a first winding 30, a second winding 40, a third winding 50, and a fourth winding 60 formed in a multi-layered structure 20 on a substrate 10. The windings 30/40/50/60 wrap each other while are separated from each other, so as to form transformer baluns with four windings. In the embodiment, the on-chip transformer 500 may further include a guard ring 70, which is composed of stacked metal rings surrounding the multi-winding structure and formed in the multi-layered structure 20. Basically, the transformer 400 is similar to that of the fifth embodiment, except that the third winding 50 is completely surrounded by the fourth winding 60 as shown in FIG. 8A in the embodiment. The first and second windings 30 and 40 may form a first transformer according to the lateral electromagnetic coupling effect therebetween. The first winding 30 acts as the primary winding of the first transformer while the second winding 40 acts as the secondary winding of the first transformer. The second and third windings 40 and 50 may form a second transformer according to the vertical electromagnetic coupling effect therebetween. The second winding 40 acts as the primary winding of the second transformer while the third winding 50 acts as the secondary winding of the second transformer. Furthermore, the third and fourth windings 50 and 60 may form a third transformer according to the lateral electromagnetic coupling effect therebetween. The third winding 50 acts as the primary winding of the third transformer while the fourth winding 60 acts as the secondary winding of the third transformer. Wherein, the second winding 40 is the common winding shared by the first and second transformers, and the third winding 50 is the common winding shared by the second and third transformers. As shown in FIG. 8A, the first winding 30 further includes a first center tap 35, which is a tap located at the winding center, to be used for a differential signal. The third winding 50 further includes a second center tap 55, which is a tap located at the winding center, to be used for a differential signal. Accordingly, an equivalent circuit of the on-chip transformer 500 in FIG. 8A can be illustrated in FIG. 8C. The first transformer can act as a transformer balun to convert a differential signal to a single-ended signal, the second transformer can act as another transformer balun to convert a single-ended signal to a differential signal, and the third transformer can act as another transformer balun to convert a differential signal to a single-ended signal.

As set forth in the embodiments, transformers with multiple windings can be integrated as a single-chip device with a small surface area and good impedance matching. With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An on-chip transformer on an integrated-circuit substrate, the on-chip transformer comprising:
a multi-winding structure, comprising first, second and third windings which are spatially separated from each other; and
a guard ring, surrounding the multi-winding structure;
wherein the first and second windings function as a first transformer, and the second and third windings function as a second transformer.

2. The on-chip transformer according to claim 1, wherein the first winding is electrically and laterally coupled to the second winding.

3. The on-chip transformer according to claim 2, wherein the second winding is electrically and vertically coupled to the third winding.

4. The on-chip transformer according to claim 1, wherein vertical views upon the substrate of the second and third windings are located inside that of the outermost coil of the first winding.

5. The on-chip transformer according to claim 1, wherein two of the first, second, and third windings have a center tap each.

6. The on-chip transformer according to claim 1, wherein both the first and second windings are substantially located in a first metal layer.

7. The on-chip transformer according to claim 6, wherein the third winding is substantially located in a second metal layer.

8. The on-chip transformer according to claim 1, wherein the first transformer converts a single-ended signal into a differential signal, and the second transformer converts a differential signal into a single-ended signal.

9. An on-chip transformer on an integrated-circuit substrate, the on-chip transformer comprising:
a first winding;
a second winding; and
a third winding;
wherein the first, second, and third windings are separated from each other and wrap around each other, the first and second windings function as a first transformer, and the second and third windings function as a second transformer.

10. The on-chip transformer according to claim 9, wherein both the first and second windings are substantially located in a first metal layer.

11. The on-chip transformer according to claim 9, wherein the third winding is substantially located in a second metal layer.

12. The on-chip transformer according to claim 9, wherein the first transformer converts a single-ended signal into a differential signal, and the second transformer converts a differential signal into a single-ended signal.

13. An on-chip transformer on an integrated-circuit substrate, the on-chip transformer comprising:
a first winding;
a second winding; and
a third winding;
wherein the first, second, and third windings are separated from each other and wrap around each other, and vertical views upon the substrate of the second and third windings are located inside that of the outermost coil of the first winding.

14. The on-chip transformer according to claim 13, wherein the first winding is electrically and laterally coupled to the second winding, and the first and second windings function as a first transformer.

15. The on-chip transformer according to claim 13, wherein the second winding is electrically and vertically coupled to the third winding, and the second and third windings function as a second transformer.

16. The on-chip transformer according to claim 13, wherein two of the first, second, and third windings have a center tap each.
